(19) United States
(12) Patent Application Publication
(10) Pub. No.: US 2017/0062810 A1
(43) Pub. Date: Mar. 2, 2017

(54) CARBON-SILICON COMPOSITE AND ANODE ACTIVE MATERIAL FOR SECONDARY BATTERY COMPRISING THE SAME

(71) Applicant: OCI COMPANY LTD., Seoul (KR)

(72) Inventors: Jeong-Hyun HA, Seongnam-si (KR); Yo-Seop KIM, Seongnam-si (KR); Eun-Hye JEONG, Seongnam-si (KR)

(21) Appl. No.: 15/247,917

(22) Filed: Aug. 26, 2016

(30) Foreign Application Priority Data
Aug. 28, 2015 (KR) 10-2015-0121510

(51) Int. Cl. H01M 4/36; H01M 4/587; H01M 4/38

(52) U.S. Cl. CPC H01M 4/364; H01M 4/366; H01M 4/386; H01M 4/587; H01M 2004/027

(57) ABSTRACT

The present invention relates to a carbon-silicon composite and an anode active material for a secondary battery comprising the same, and more particularly, a carbon-silicon composite in which silicon (Si)-block copolymer core-shell particles are uniformly dispersed and embedded in a carbonaceous substance.

### BACKGROUND

1. Technical Field

The present invention relates to a carbon-silicon composite and an anode active material for a secondary battery comprising the same, and more particularly, to a carbon-silicon composite in which silicon (Si)-block copolymer core-shell particles are uniformly dispersed and embedded in a carbonaceous substance.

2. Description of the Related Art

A lithium secondary battery is widespread as a power source of various equipments due to characteristics such as high energy density, high voltage, and high capacity as compared to other secondary batteries.

In particular, it is required to have an anode active material of the lithium secondary battery capable of implementing high capacity in order to be used for a battery for an information technology (IT) equipment or a battery for an automobile.

In general, carbon-based materials such as graphite, etc., are mainly used as the anode active material of the lithium secondary battery. Since a theoretical capacity of the graphite is about 372 mAh/g, and in consideration of capacity loss, etc., an actual discharge capacity thereof is merely about 310 to 330 mAh/g, demand for a lithium secondary battery having much higher energy density has been increased.

In accordance with the demand, research into metal, alloy, etc., as the anode active material of the lithium secondary battery having high capacity has been conducted, and in particular, research into silicon has received attention.

For example, it is known that a high theoretical capacity of pure silicon is 4,200 mAh/g.

However, a silicon material has a reduced cycle characteristic as compared to the carbon-based material, which is still an obstacle for practical use.

The reason is that when inorganic particles such as silicon as the anode active material are directly used as a material for absorbing and releasing lithium, conductivity between the active materials is deteriorated or the anode active material is separated from an anode current collector due to volume change of silicon in a charge and discharge process.

Specifically, the inorganic particles such as silicon included in the anode active material absorb lithium by a charge process to expand so as to be about 300% to 400% in volume, and when the lithium is released by a discharge process, the inorganic particles are contracted again.

If the charge and discharge cycles are repeated, electrical insulation may occur due to empty space generated between the inorganic particles and the anode active material, which may cause rapid deterioration in lifespan, and therefore, silicon has a serious problem in being used for a secondary battery.

Further, if the silicon is not present in a state in which it is not sufficiently dispersed in the anode active material, or if the silicon is present only on a surface of the anode active material, the above-described problem of volume change may become more serious.

In order to solve this problem, the most important thing is to uniformly disperse silicon, and accordingly, various attempts such as an attempt to control a particle size of silicon or at attempt to form pores, etc., have been conducted. However, it is difficult to confirm a degree of dispersion.

Therefore, it is required to develop an anode active material capable of inhibiting separation from the anode active material and having sufficient battery capacity and excellent cycle characteristics by uniformly dispersing silicon in the anode active material, and simultaneously confirming the degree of dispersion to reduce the volume change of silicon.

### BRIEF SUMMARY

It is an aspect of the present invention to provide a carbon-silicon composite in which silicon (Si)-block copolymer core-shell particles are embedded in a carbonaceous substance,

wherein a cross sectional image of the carbon-silicon composite is taken by scanning electron microscope (SEM), and the image is divided into nine equal parts in a three-by-three matrix,

0≦|Xₙ−Y|≦0.5Y is satisfied, Equation (1)

wherein Xₙ (n is an integer of 1 to 9) denotes a ratio (%) of an area occupied by nano silicon (Si) fine particles to an area of the composite in each of the nine equal parts, and Y denotes an average value of a ratio (%) of the area occupied by the nano silicon (Si) fine particles to the area of the composite in whole parts.

A difference between any two values of Xₙ (n is an integer of 1 to 9) may be 0.5Y or less.

In addition,

$$0 \leq \frac{\begin{matrix}{\sum }_{n = 1}^{6} \vert {X}_{n + 3} - {X}_{n} \vert + \\ {\sum }_{n = 1}^{3} ( \vert {X}_{3 n} - {X}_{3 n - 1} \vert + \vert {X}_{3 n - 1} - {X}_{3 n - 2} \vert )\end{matrix}}{12} \leq 0.3 Y \qquad Equation ( 2 )$$

may be satisfied.

As described above, the carbon-silicon composite in which the silicon (Si)-block copolymer core-shell particles are uniformly dispersed in the carbonaceous substance may be provided, such that an anode active material in which silicon is uniformly dispersed in a secondary battery may be provided, whereby charge and discharge characteristic and lifespan characteristic of the secondary battery may be improved.

### BRIEF DESCRIPTION OF THE DRAWINGS

FIG. 1 schematically illustrates nine equal parts (X₁ to X₉ parts) of a cross sectional image of a carbon-silicon composite according to the present invention taken by scanning electron microscope (SEM) and divided in a three-by-three matrix.

FIG. 2 illustrates a dispersion degree of nano silicon (Si) fine particles measured through computer image processing from the image of the carbon-silicon composite according to Example 1 of the present invention taken by the SEM.

FIG. 3 illustrates a dispersion degree of nano silicon (Si) fine particles measured through computer image processing from the image of the carbon-silicon composite according to Example 2 of the present invention taken by the SEM.

FIG. 4 illustrates a dispersion degree of nano silicon (Si) fine particles measured through computer image processing from the image of the carbon-silicon composite according to Example 3 of the present invention taken by the SEM.

FIG. 5 illustrates a dispersion degree of nano silicon (Si) fine particles measured through computer image processing from the image of the carbon-silicon composite according to Example 4 of the present invention taken by the SEM.

FIG. 6 illustrates a dispersion degree of nano silicon (Si) fine particles measured through computer image processing from the image of the carbon-silicon composite according to Example 5 of the present invention taken by the SEM.

FIG. 7 illustrates a dispersion degree of nano silicon (Si) fine particles measured through computer image processing from the image of the carbon-silicon composite according to Comparative Example of the present invention taken by the SEM.

### DETAILED DESCRIPTION

Hereinafter, various advantages and features of the present invention and methods accomplishing thereof will become apparent with reference to the following description of Examples. However, the present invention is not limited to exemplary embodiments disclosed below but will be implemented in various forms. These exemplary embodiments are provided by way of example only so that a person of ordinary skilled in the art can fully understand the disclosures of the present invention and the scope of the present invention. Therefore, the present invention will be defined only by the scope of the appended claims. Like reference numerals refer to like components throughout the specification.

Hereinafter, the present invention will be described in detail.

According to the related art, when silicon is included as an anode active material to implement a battery having high capacity, there are problems in that conductivity is deteriorated or the anode active material is separated from an anode current collector due to a volume change of silicon (Si) in a charge and discharge process of a battery.

Further, the above-described problems are more pronounced if silicon (Si) is not uniformly dispersed in the anode active material.

Accordingly, the present inventors developed a carbon-silicon composite capable of preventing agglomeration of silicon (Si)-block copolymer core-shell particles during a process for manufacturing the composite by using the silicon (Si)-block copolymer core-shell particles together with a carbonaceous substance, the silicon (Si)-block copolymer core-shell particles include nano silicon (Si) fine particles as a core, and has a spherical micelle structure formed by a block copolymer on the basis of the nano silicon fine particles, and as a result, silicon is uniformly well-dispersed in the carbonaceous substance.

As described above, the silicon (Si)-block copolymer core-shell particles may be uniformly dispersed throughout the carbonaceous substance of the carbon-silicon composite.

When the carbon-silicon composite is applied for the anode active material of the lithium secondary battery, a volume expansion problem in the charge and discharge process may be alleviated while effectively exhibiting high capacity of silicon characteristic, such that lifespan characteristic of the lithium secondary battery may be improved.

The carbon-silicon composite in which the silicon (Si)-block copolymer core-shell particles are uniformly well-dispersed may implement much more excellent capacity even though it includes the same content of silicon. For example, about 80% or more of theoretical capacity of silicon may be implemented.

In addition, the present inventors found that the nano silicon (Si) fine particles are uniformly dispersed in the carbonaceous substance on a cross-section of the composite taken by scanning electron microscope (SEM), and suggested the criteria that may indicate a degree of dispersion, such that the carbon-silicon composite having more uniform dispersion degree when applied to the secondary battery could be provided.

The present invention may provide a carbon-silicon composite in which silicon (Si)-block copolymer core-shell particles are embedded in a carbonaceous substance, wherein a cross sectional image of the carbon-silicon composite is taken by scanning electron microscope (SEM), and the image is divided into nine equal parts in a three-by-three matrix, Equation (1) 0≦|Xₙ−Y|≦0.5Y, preferably, 0≦|Xₙ−Y|≦0.3Y, and more preferably, 0≦|Xₙ−Y|≦0.2Y, is satisfied, wherein Xₙ (n is an integer of 1 to 9) denotes a ratio (%) of an area occupied by nano silicon (Si) fine particles to an area of the composite in each of the nine equal parts, and Y denotes an average value of a ratio (%) of the area occupied by the nano silicon (Si) fine particles to the area of the composite in whole parts.

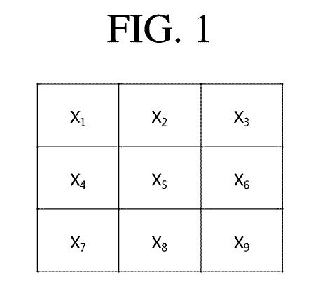

Referring to FIG. 1, nine equal parts in the cross sectional image of the carbon-silicon composite according to the present invention taken by SEM and respective positions of X₁ to X₉ parts may be schematically confirmed.

The equation (1) represents the dispersion degree of the nano silicon (Si) in the carbon-silicon composite, and an absolute value of a deviation of the average value of the ratio (%) of the area occupied by the nano silicon (Si) fine particles in whole parts and the ratio (%) of the area occupied by the nano silicon (Si) fine particles in each part may be ½ or less than the average value.

Specifically, the area occupied by the nano silicon (Si) fine particles in each part may be 0.5 to 1.5 times the average value of the area occupied by the nano silicon (Si) fine particles in whole parts.

Preferably, the area occupied by the nano silicon (Si) fine particles in each part may be 0.7 to 1.3 times, more preferably, 0.85 to 1.15 times, and the most preferably, about 1 time the average value of the area occupied by the nano silicon (Si) fine particles in whole parts, wherein silicon (Si) is the most uniformly dispersed in every part.

When the absolute value of a deviation of the ratio (%) of the nano silicon (Si) fine particles in each part to the average value of the ratio (%) of the nano silicon (Si) fine particles in whole parts is more than 0.5 times of the average value, it indicates that the nano silicon (Si) fine particles in the carbon-silicon composite are not uniformly dispersed, wherein since it is difficult to achieve a sufficient buffering action in the carbonaceous substance with regard to silicon (Si), a problem that lifespan characteristic of the battery is deteriorated when applied to the battery may occur.

Accordingly, when each value of |Xₙ−Y| (n is an integer of 1 to 9) becomes smaller, the silicon (Si)-block copolymer core-shell particles according to the present invention are uniformly dispersed in the carbonaceous substance, wherein the nano silicon (Si) fine-particles are neither agglomerated nor biased to one side, and the carbon-silicon composite having these characteristics may alleviate a volume expansion problem in the charge and discharge process while effectively exhibiting high capacity of silicon characteristic when applied to an electrode for a secondary battery, such that lifespan characteristic of the lithium secondary battery may be improved.

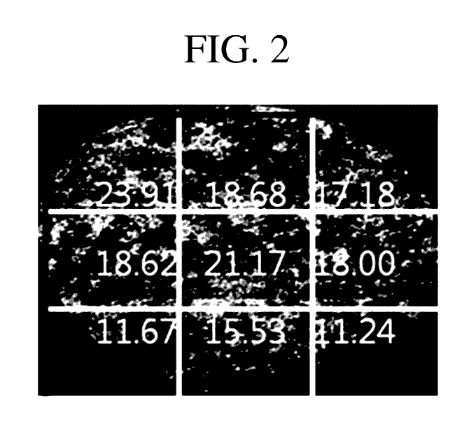

For example, FIG. 2 illustrates results obtained by measuring the ratios (%) of the nano silicon (Si) fine particles through computer image processing from images of the carbon-silicon composite according to an exemplary embodiment of the present invention taken by SEM.

Specifically, FIG. 2 illustrates a carbon-silicon composite manufactured so as to include 20 wt % of nano silicon (Si) fine particles with regard to total weight of the carbon-silicon composite.

As described above, it is important to uniformly disperse the silicon (Si)-block copolymer core-shell particles in the carbonaceous substance, such that the nano silicon (Si) fine particles are uniformly dispersed in an anode of the secondary battery using the composite.

In the carbon-silicon composite according to FIG. 2, the average value Y of the ratio (%) of the nano silicon (Si) fine particles in the whole parts is rounded to three decimal places, which is 19.98%. The ratio (%) of the area occupied by the nano silicon (Si) fine particles may be different from the initial content of the nano silicon (Si) fine particles, 20 wt %, due to loss during the process for manufacturing the carbon-silicon composite by stirring, heat treatment, pulverization, etc., performed in manufacturing the composite, and difference in atomic weight between carbon and silicon (Si).

In FIG. 2, X₁ is 19.48, X₂ is 20.18, X₃ is 18.14, X₄ is 21.38, X₅ is 21.12, X₆ is 21.75, X₇ is 17.95, X₈ is 20.76, X₉ is 19.07, and 0.5Y is 9.99, and accordingly, |X₁−Y|=0.5, |X₂−Y|=0.2, |X₃−Y|=1.84, |X₄−Y|=1.4, |X₅−Y|=1.14, |X₆−Y|=1.77, |X₇−Y|=2.03, |X₈−Y|=0.78, |X₉−Y|=0.91, all of which are lower than 9.99, such that Equation (1) is satisfied. Therefore, it may be confirmed in the carbon-silicon composite of FIG. 2 that the silicon (Si)-block copolymer core-shell particles are well-dispersed in the carbonaceous substance, such that silicon is uniformly dispersed in the composite.

In particular, it may be appreciated that the greatest value of the calculated data is |X₇−Y|=2.03, i.e., about 0.1Y, wherein silicon is very well-dispersed.

As described above, the carbon-silicon composite having improved dispersibility of the nano silicon (Si) fine particles in the carbonaceous substance may be provided to have excellent buffering action against volume change of silicon (Si) that may occur when charge and discharge cycles are repeated in the anode of the secondary battery.

In addition, a difference between any two values of Xₙ (n is an integer of 1 to 9) obtained by dividing the cross-section of the carbon-silicon composite according to the present invention taken by SEM into the nine equal parts may be 0.5Y or less.

Possible differences among the nine equal parts are a total of 36 values, all of which are 0.5Y or less, such that it is possible to confirm uniform distribution of silicon embedded in the carbon-silicon composite.

These values may be measured even between adjacent parts and even between parts that are not adjacent to each other but are spaced apart from each other, and distribution relationship between parts in the whole cross-section may be explained.

Further, Xₙ obtained by dividing the cross-section of the carbon-silicon composite according to the present invention taken by SEM into the nine equal parts may satisfy

$$0 \leq \frac{\begin{matrix}{\sum }_{n = 1}^{6} \vert {X}_{n + 3} - {X}_{n} \vert + \\ {\sum }_{n = 1}^{3} ( \vert {X}_{3 n} - {X}_{3 n - 1} \vert + \vert {X}_{3 n - 1} - {X}_{3 n - 2} \vert )\end{matrix}}{12} \leq 0.3 Y , \qquad Equation ( 2 )$$

and preferably,

$$0 \leq \frac{\begin{matrix}{\sum }_{n = 1}^{6} \vert {X}_{n + 3} - {X}_{n} \vert + \\ {\sum }_{n = 1}^{3} ( \vert {X}_{3 n} - {X}_{3 n - 1} \vert + \vert {X}_{3 n - 1} - {X}_{3 n - 2} \vert )\end{matrix}}{12} \leq 0.2 Y .$$

The equation (2) represents an average of differences between adjacent parts in each nine equal part of the cross-section of the carbon-silicon composite taken by SEM.

Specifically, by confirming that the average of differences between X₁ and X₂, X₁ and X₄, X₂ and X₃, X₂ and X₅, X₃ and X₆, X₄ and X₅, X₄ and X₇, X₅ and X₆, X₅ and X₈, X₆ and X₉, X₇ and X₈, and X₈ and X₉ parts is ( ) or less, it is possible to confirm dispersion degree of the parts smaller than those of original SEM image.

For example, in FIG. 2, the values are 0.2, 1.9, 2.04, 0.94, 3.61, 0.26, 3.43, 0.63, 0.36, 2.68, 2.81, and 1.69, respectively, in the above-described order, and the average thereof is rounded to three decimal places, which is 1.71, i.e., about 0.09Y, and accordingly, it may be appreciated in the cross-section of the carbon-silicon composite that dispersion is well-achieved even between local parts.

Specifically, the carbon-silicon composite according to the present invention allows the silicon (Si)-block copolymer core-shell particles to be uniformly dispersed in the carbonaceous substance, such that it is possible to provide the carbon-silicon composite in which the nano silicon (Si) fine-particles are neither agglomerated nor biased to one side, but are uniformly trapped in amorphous carbon.

In the silicon (Si)-block copolymer core-shell particles, silicon (Si) core; and a block copolymer shell may form a spherical micelle structure on the basis of the silicon (Si) core, the block copolymer shell including blocks having a high affinity with silicon and blocks having a low affinity with silicon.

The silicon (Si)-block copolymer core-shell particle has a structure in which a surface of the silicon (Si) core is coated with the block copolymer shell consisting of the blocks having a high affinity with silicon and the blocks having a low affinity with silicon, on the basis of the silicon core formed of the nano silicon (Si) fine particles. The block copolymer shell of the silicon (Si)-block copolymer core-shell particles forms a spherical micelle structure in which the blocks having a high affinity with silicon are gathered toward the surface of the silicon (Si) core, and the blocks having a low affinity with silicon are gathered toward the outside due to van der Waals force, etc.

A weight ratio between the silicon (Si) core and the block copolymer shell is preferably 2:1 to 1000:1, and more preferably, 4:1 to 20:1, but the weight ratio between the silicon (Si) core and the block copolymer shell is not limited thereto.

Here, when the weight ratio between the silicon (Si) core and the block copolymer shell is less than 2:1, a content of the silicon (Si) core capable of being practically alloyed with lithium in the anode active material becomes decreased, which reduces a capacity of the anode active material and deteriorates efficiency of a lithium secondary battery.

On the contrary, when the weight ratio between the silicon (Si) core and the block copolymer shell is more than 1000:1, the content of the block copolymer shell becomes decreased, which reduces dispersibility and stability in a slurry solution, such that there is problem in that the block copolymer shell of the core-shell carbonization particles is not able to properly perform a buffering action in the anode active material.

The blocks having a high affinity with silicon are gathered toward the surface of the silicon (Si) core due to van der Waals force, etc.

Here, the block having a high affinity with silicon (Si) is preferably poly acrylic acid, poly acrylate, poly methacrylic acid, poly methyl methacrylate, poly acryamide, carboxymethyl cellulose, poly vinyl acetate, or polymaleic acid, but the present invention is not limited thereto.

The blocks having a low affinity with silicon are gathered toward the outside due to van der Waals force, etc.

Here, the block having a low affinity with silicon (Si) is preferably poly styrene, poly acrylonitrile, poly phenol, poly ethylene glycol, poly lauryl methacrylate, or poly vinyl difluoride, but the present invention is not limited thereto.

The block copolymer shell is the most preferably polyacrylic acid-poly styrene block copolymer shell.

A number average molecular weight (Mn) of the poly acrylic acid is preferably 100 g/mol to 100,000 g/mol, and a number average molecular weight (Mn) of the poly styrene is preferably 100 g/mol to 100,000 g/mol, but the number average molecular weight (Mn) of the poly acrylic acid or the poly styrene is not limited thereto.

When 90% cumulative mass-particle size distribution diameter is D90, and 50% cumulative mass-particle size distribution diameter is D50 in a particle distribution in a slurry solution of the silicon (Si)-block copolymer core-shell particle, 1≦D90/D50≦1.4, and 2 nm<D50<120 nm is preferred, but the present invention is not limited thereto.

Here, the slurry solution refers to a slurry including the silicon (Si)-block copolymer core-shell particles and a dispersion medium.

Since the block copolymer shell of the silicon (Si)-block copolymer core-shell particles forms the spherical micelle structure on the basis of the silicon (Si) core, dispersibility in the slurry solution is excellent as compared to silicon particles that do not include separate block copolymers, such that agglomeration phenomenon between particles is reduced, whereby D50 in the slurry solution may be small and uniform distribution in which a size deviation between the particles is small may be provided. Accordingly, the silicon (Si)-block copolymer core-shell particles may be uniformly well-dispersed in the carbonaceous substance.

In addition, the carbon-silicon composite may be formed as spherical particles or nearly spherical particles. The carbon-silicon composite 1 may have a particle diameter of 0.5 μm to 50 μm, preferably, 1 μm to 30 μm, and more preferably, 3 μm to 20 μm.

When the carbon-silicon composite having the above-described range of particle size is applied for an anode active material of a secondary battery, a volume expansion problem in the charge and discharge process may be alleviated while effectively exhibiting high capacity of silicon characteristic, such that lifespan characteristic of the lithium secondary battery may be improved.

In the carbon-silicon composite 1, a mass ratio of silicon to carbon may be 0.5:99.5 to 30:70.

The carbon-silicon composite 1 is capable of containing a high content of silicon even within the above-described numerical scope, and also includes the well-dispersed silicon (Si)-block copolymer core-shell particles even while containing the high content of silicon, such that the volume expansion problem in the charge and discharge process caused when silicon is used as the anode active material, may be improved.

The carbonaceous substance may be an amorphous carbon, and may be a soft carbon or a hard carbon.

In addition, for example, the carbon-silicon composite rarely includes oxides that are possible to deteriorate performance of the secondary battery, such that an oxygen content of the carbon-silicon composite is significantly low. Specifically, the carbon-silicon composite may have an oxygen content of 1 wt % or less.

Further, the carbonaceous substance rarely includes other impurities and by-product compounds, and mostly consists of carbon. Specifically, the carbonaceous substance may have a carbon content of 70 wt % to 100 wt %.

In addition, the present invention may provide silicon (Si)-block copolymer core-shell carbonization particles formed by carbonizing the silicon (Si)-block copolymer core-shell particles, and accordingly, carbon-silicon composite particles including the silicon (Si)-block copolymer core-shell carbonization particles may be provided. In particular, the block having a low affinity with silicon is characterized by a higher carbonization yield than that of the block having a high affinity with silicon at the time of carbonization.

Specifically, the block copolymer shell of the silicon (Si)-block copolymer core-shell carbonization particles may form a spherical carbonization film on the basis of the silicon (Si) core.

In the present specification, the expression in which the silicon (Si)-block copolymer core-shell particles are uniformly well-dispersed means that the silicon (Si)-block copolymer core-shell particles are uniformly dispersed throughout the carbonaceous substance, and also means that the silicon (Si)-block copolymer core-shell carbonization particles are uniformly dispersed.

That is, the silicon (Si)-block copolymer core-shell particles in the carbon-silicon composite are well-dispersed, and accordingly, the silicon (Si)-block copolymer core-shell carbonization particles obtained by carbonizing the silicon (Si)-block copolymer core-shell particles are also well-dispersed.

Specifically, the carbon-silicon composite including the silicon (Si)-block copolymer core-shell carbonization particles may have a particle diameter of 20 μm or less.

For example, an average diameter of the carbon-silicon composite may be 3 μm to 20 μm.

In addition, in the case of the block copolymer shell particle, at the time of carbonization, other impurities such as oxygen, hydrogen, etc., except carbon in the block copolymer shell particles and by-product compounds are not carbonized but are vaporized.

Therefore, since space in which other impurities such as oxygen, hydrogen, etc., except carbon and by-product compounds are present remains as an empty space, high porosity may be obtained as compared to the carbonaceous substance mostly consisting of carbon only.

In addition, the block copolymer shell carbonization particle preferably has a carbonization yield of 5% to 30%, and the carbonaceous substance preferably has a carbonization yield 40% to 80%, but the present invention is not limited thereto.

The carbonaceous substance rarely includes other impurities and by-product compounds, but mostly consists of carbon only, such that the carbonization yield in a carbonization process is remarkably excellent. The block copolymer shell carbonization particles include other impurities such as oxygen, hydrogen, etc., except carbon, and by-product compounds, such that the carbonization yield in the carbonization process is deteriorated.

In addition, the present invention may provide an anode active material for a secondary battery including: a core layer consisting of the carbon-silicon composite as described above; and a shell layer homogeneously coated on the surface of the core layer and including a conductive material and a carbon material for fixing the conductive material.

The anode active material for a secondary battery according to the present invention includes the carbon-silicon composite core layer, wherein the core layer may include nano silicon (Si) fine particles uniformly dispersed in the carbonaceous substance.

As described above, silicon is overally and uniformly well-dispersed in the core layer, such that when the carbon-silicon composite is applied for the anode active material of a secondary battery, the volume expansion problem in the charge and discharge process may be alleviated while effectively exhibiting high capacity of silicon characteristic, such that lifespan characteristic of the secondary battery may be improved. The core layer in which silicon is uniformly well-dispersed may implement much more excellent capacity even though it includes the same content of silicon. For example, about 80% or more of theoretical capacity of silicon may be implemented.

Here, the core layer may be formed of spherical particles or nearly spherical particles. The core layer may have a particle diameter of 0.5 μm to 50 μm, preferably, 1 μm to 30 μm, and more preferably, 3 μm to 20 μm.

When the core layer having the above-described range of particle size is applied for an anode active material of a secondary battery, the volume expansion problem in the charge and discharge process may be alleviated while effectively exhibiting high capacity of silicon characteristic, such that lifespan characteristic of the secondary battery may be improved.

The core layer preferably has a content of 60 wt % to 99 wt %, and more preferably, 60 wt % to 90 wt % with regard to total content of the anode active material, but the content of the core layer is not limited thereto.

When the content of the core layer with regard to the anode active material is less than the above-described range, silicon content is small, such that an initial charge capacity is small. When the content of the core layer with regard to the anode active material is more than the above-described range, the shell layer includes a small content of conductive materials, such that conductivity is not sufficient.

Further, the anode active material for a secondary battery according to the present invention includes the conductive material and the carbon material for fixing the conductive material, wherein the shell layer is homogeneously coated on the surface of the core layer to have a stereotyped structure having a predetermined form.

Since the shell layer is characterized by including the conductive material, the anode active material for a secondary battery including the conductive material has high conductivity, such that the number of conductively available contact sites between the carbon-silicon composite core layer and the anode current collector are increased, thereby more improving charge and discharge stability of the secondary battery.

Here, the shell layer may have a thickness of 1 μm to 8 μm.

The conductive material in the shell layer preferably has a content of 1 wt % to 40 wt %, and more preferably, 3 wt % to 30 wt % with regard to the anode active material, but the content of the conductive material is not limited thereto.

When the content of the core layer with regard to the anode active material is less than the above-described range, a content of the conductive materials such as carbon black, etc., is small, such that conductivity is not sufficient. When the content of the core layer with regard to the anode active material is more than the above-described range, the core layer includes a small content of silicon, such that an initial charge capacity is small.

The conductive material in the shell layer preferably includes, without limitation, at least one selected from the group consisting of carbon black, acetylene black, Ketjen black, furnace black, carbon fiber, fullerene, copper, nickel, aluminum, silver, cobalt oxide, titanium oxide, polyphenylene derivative, polythiophene, polyacene, polyacetylene, polypyrrole, polyaniline and a combination thereof, and more preferably, carbon black.

The carbon black used as the conductive material is conductive, and corresponds to fine carbon powder produced by incomplete combustion of the carbon-based compound, and may have a particle diameter of 1 nm to 500 nm.

Further, the carbon material for fixing the conductive material in the shell layer may include at least one selected from the group consisting of natural graphite, artificial graphite, soft carbon, hard carbon, pitch carbide, calcined coke, graphene, carbon nanotube, and a combination thereof.

The carbon material for fixing the conductive material allows the conductive material to be fixed in the stereotype so that the shell layer is capable of being homogeneously coated on the surface of the core layer, such that it is possible to prevent the existing problem that the conductive material is not present in the anode active material for a secondary battery, but is present in an amorphous form, which causes blowing dust.

The carbon material for fixing the conductive material is preferably a pitch carbide including components insoluble in quinoline (QI) of 0 wt % to 10 wt %, and having a softening point (SP) of 284° C., but the present invention is not limited thereto.

Here, the carbon material for fixing the conductive material may have a content of 1 wt % to 20 wt % with regard to the anode active material.

Hereinafter, preferred exemplary embodiments of the present invention are described to assist in understanding the present invention. However, the following exemplary embodiments are provided only to more easily understand the present invention, and accordingly, the present invention is not limited thereto.

### EXAMPLE AND COMPARATIVE EXAMPLE

### Example

A poly acrylic acid-poly styrene block copolymer was synthesized by using poly acrylic acid and poly styrene through a reversible addition-fragmentation chain transfer method. Here, the poly acrylic acid had a number average molecular weight (Mₙ) of 4090 g/mol, and the poly styrene had a number average molecular weight (Mₙ) of 29370 g/mol. 0.1 g of the poly acrylic acid-poly styrene block copolymer was mixed with 8.9 g of N-methyl-2-pyrrolidone (NMP) dispersion medium. 1 g of silicon (Si) particles each having an average particle diameter of 50 nm were added to 9 g of the mixed solution. The solution to which the silicon (Si) particles are added was treated with 20 kHz of ultrasound for 10 minutes by using a sonic horn, followed by pause for 20 minutes, thereby preparing a mixed solution including silicon (Si)-block copolymer core-shell particles.

The mixed solution was mixed with coal-based pitch and stirred for about 30 minutes to prepare a mixed solution in which the coal-based pitch is dissolved in the NMP dispersion medium. Here, the coal-based pitch and the silicon (Si)-block copolymer core-shell particles were mixed at a weight ratio of 97.5: 2.5. The NMP dispersion medium was evaporated at a temperature of 110° C. to 120° C. under vacuum condition. Then, a carbonization process was performed at a temperature of 900° C. for 5 hours by raising a temperature at a rate of 10° C./min to form a silicon-carbon composite. The formed carbon-silicon composite was subjected to planetary ball milling at 220 rpm for 1 hour, followed by classification process, thereby obtaining a carbon-silicon composite including particles each selected only having a particle size of 3 μm to 20 μm.

Here, a content of the silicon (Si) fine particles with regard to the total content of the carbon-silicon composite was 20 wt %, and the carbon-silicon composite having a particle size of 10 μm was selected.

### Example 2

A carbon-silicon composite was manufactured by the same method as Example 1 above except that the carbon-silicon composite having a particle size of 3 μm was selected.

### Example 3

A carbon-silicon composite was manufactured by the same method as Example 1 above except that a content of the silicon (Si) fine particles with regard to the total content of the carbon-silicon composite was 25 wt %, and the carbon-silicon composite having a particle size of 6 μm was selected.

### Example 4

A carbon-silicon composite was manufactured by the same method as Example 1 above except that a content of the silicon (Si) fine particles with regard to the total content of the carbon-silicon composite was 30 wt %, and the carbon-silicon composite having a particle size of 5 μm was selected.

### Example 5

A carbon-silicon composite was manufactured by the same method as Example 1 above except that a content of the silicon (Si) fine particles with regard to the total content of the carbon-silicon composite was 30 wt %, and the carbon-silicon composite having a particle size of 8μm was selected.

### Comparative Example

A carbon-silicon composite was manufactured by the same method as Example except that poly acrylic acid and poly styrene were dispersed in N-methyl-2-pyrrolidone (NMP), and then, silicon was not added, but silicon was directly dispersed in the NMP and mixed with coal-based pitch.

Here, a content of the silicon (Si) fine particles with regard to the total content of the carbon-silicon composite was 20 wt %, particles each having a particle size of 10 μm was selected through the classification process.

Each content of the silicon (Si) fine particles of the carbon-silicon composites according to Examples 1 to 5 and Comparative Example, and each particle size thereof were shown in Table 1 below.

TABLE 1

| | Content of sililcon (Si) | | |
|---|---|---|---|
| | fine particles to total content | Particle | |
| | of carbon-silicon composite | size | |
| Example 1 | 20 wt % | 10 | μm |
| Example 2 | 20 wt % | 3 | μm |
| Example 3 | 25 wt % | 6 | μm |
| Example 4 | 30 wt % | 5 | μm |
| Example 5 | 30 wt % | 8 | μm |
| Comparative | 20 wt % | 10 | μm |
| Example | | | |

### Experimental Example

<Experimental Method>

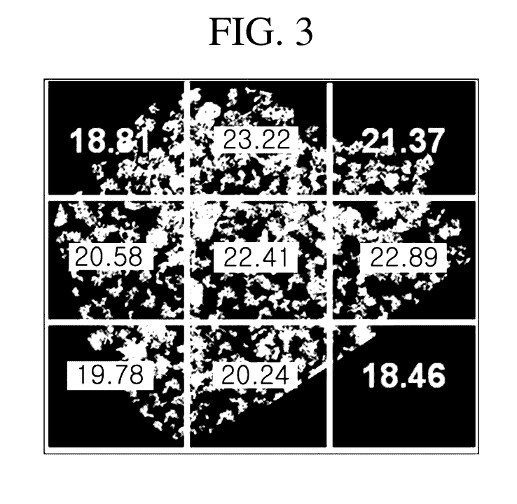

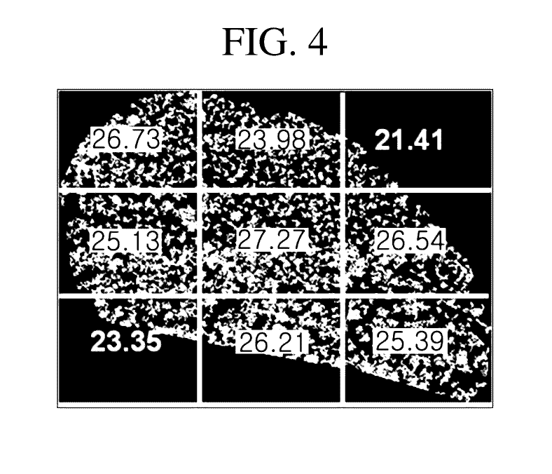

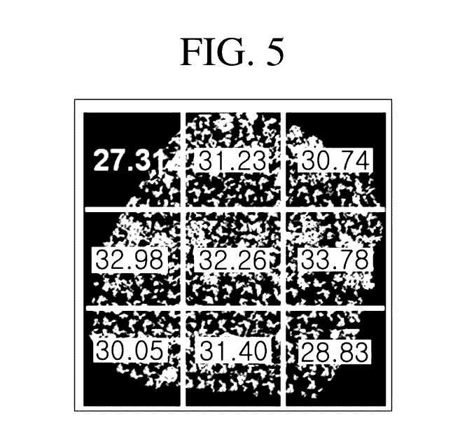

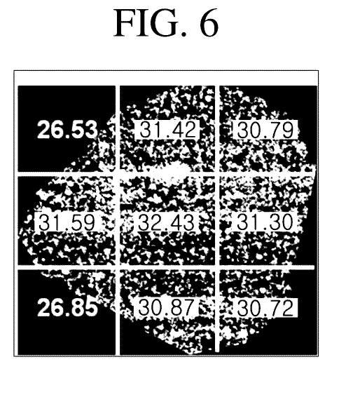

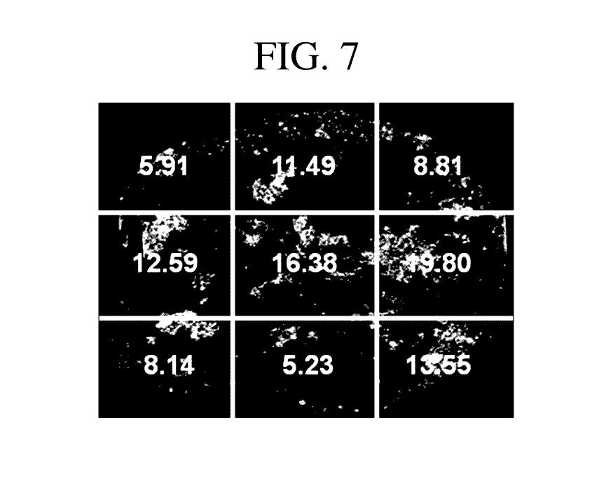

The composites manufactured from Examples and Comparative Example were cut by focus ion beam (FIB), and cross sectional images of the carbon-silicon composites were taken by scanning electron microscope (SEM). Then, areas occupied by silicon to carbon in the images obtained through single exposure processing of Matlab were calculated, and Example 1 was illustrated in FIG. 2, and Example 2 was illustrated in FIG. 3, and Example 3 was illustrated in FIG. 4, Example 4 was illustrated in FIG. 5, Example 5 was illustrated in FIG. 6, and Comparative Example was illustrated in FIG. 7, respectively.

<Experimental Results>

It may be appreciated from FIG. 2 that in Example 1, Y/2=9.99, |X₁−Y|=0.5, |X₂−Y|=0.2, |X₃−Y|=1.84, |X₄−Y|=1.4, |X₅−Y|=1.14, |X₆−Y|=1.77, |X₇−Y|=2.03, |X₈−Y|=0.78, |X₉−Y|=0.91, all of which are smaller than 9.99, such that Equation (1) above is satisfied.

It may be appreciated from FIG. 3 that in Example 2, Y/2=10.71, |X₁−Y|=2.61, |X₂−Y|=6.80, |X₃−Y|=0.05, |X₄−Y|=0.84, |X₅−Y|=0.99, |X₆−Y|=1.47, |X₇−Y|=1.64, |X₈−Y|=1.18, |X₉−Y|=2.96, all of which are smaller than 10.71, Equation (1) above is satisfied.

It may be appreciated from FIG. 4 that in Example 3, Y/2=12.56, |X₁−Y|=1.62, |X₂−Y|=1.13, |X₃−Y|=3.70, |X₄−Y|=0.02, |X₅−Y|=2.16, |X₆−Y|=1.43, |X₇−Y|=1.76, |X₈−Y|=1.10, |X₉−Y|=0.28, all of which are smaller than 12.56, such that Equation (1) above is satisfied.

It may be appreciated from FIG. 5 that in Example 4, Y/2=15.48, |X₁−Y|=3.64, |X₂−Y|=0.28, |X₃−Y|=0.21, |X₄−Y|=2.03, |X₅−Y|=1.31, |X₆−Y|=2.83, |X₇−Y|=0.90, |X₈−Y|=0.45, |X₉−Y|=2.12, all of which are smaller than 15.48, such that Equation (1) above is satisfied.

It may be appreciated from FIG. 6 that in Example 5, Y/2=15.14, |X₁−Y|=3.75, |X₂−Y|=1.14, |X₃−Y|=0.51, |X₄−Y|=1.31, |X₅−Y|=2.15, |X₆−Y|=1.02, |X₇−Y|=3.43, |X₈−Y|=0.59, |X₉−Y|=0.44, all of which are smaller than 15.14, such that Equation (1) above is satisfied.

In particular, it may be appreciated that in Examples 1, 3, 4, and 5, the ratio (Xₙ) of the area occupied by nano silicon (Si) fine particles in each part is smaller than 0.2Y, such that dispersion is very well-achieved.

Accordingly, it may be confirmed that according to the carbon-silicon composite of the present invention, the silicon (Si)-block copolymer core-shell particles are overally and uniformly dispersed in the carbonaceous substance, such that the nano silicon (Si) fine particles are uniformly dispersed in the composite.

On the contrary, according to the composite of Comparative Example, a difference in silicon content is large, and agglomeration of particles is largely present as illustrated in FIG. 7. When calculating the results of Comparative Example according to Equation (1) of the present invention, the average Y is rounded to three decimal places, which is 11.32, such that 0.5Y is 5.66, and |X₁−Y|=5.41, |X₂−Y|=0.17, |X₃−Y|=2.51, |X₄−Y|=1.27, |X₅−Y|=5.06, |X₆−Y|=8.48, |X₇−Y|=3.18, |X₈−Y|=6.09, and |X₉−Y|=2.23, that is, four parts have values close to or larger than 0.5Y, i.e., 5.66, which may be appreciated that Equation (1) is not satisfied, and dispersion is not well-achieved.

In addition to the visual results, it may be appreciated from FIG. 7 illustrating Comparative Example that in view of conversion into dispersion degree, the ratio of the area occupied by the nano silicon (Si) fine particles in each part is not uniform, and has a large difference from the average value of the ratio of the nano silicon (Si) fine particles in whole parts.

Accordingly, it may be appreciated that the composite of Comparative Example has parts in which dispersion of silicon in carbon is not effectively achieved, such that silicon is agglomerated or silicon is not present, which may deteriorate lifespan characteristic, etc., of the secondary battery when applied to the battery. On the contrary, according to the carbon-silicon composite of the present invention, the silicon (Si)-block copolymer core-shell particles are dispersed in the carbonaceous substance, and as a result, the distribution of the nano silicon (Si) fine particles in the composite is significantly uniform, such that charge and discharge characteristic and lifespan characteristic of the secondary battery when applied to the battery may be improved.

It was confirmed from Examples and Comparative Example that when silicon (Si) is well-dispersed in the carbon-silicon composite, Equation (1) is satisfied, and simultaneously, by directly confirming the silicon (Si) dispersion of the cross-section, when Equation (1) is satisfied, dispersion is also well-achieved. In addition, it was confirmed from Examples and Comparative Example that when silicon (Si) is not well-dispersed in the carbon-silicon composite, Equation (1) is not satisfied, and simultaneously, when Equation (1) is not satisfied, dispersion is not well-achieved, either.

The carbon-silicon composite of the present invention includes silicon (Si)-block copolymer core-shell particles that are very uniformly dispersed therein, such that when the carbon-silicon composite is used as the anode active material for a secondary battery, electrical conductivity in the electrode may be improved, and a silicon (Si) content in the anode active material may be increased.

Further, when the carbon-silicon composite is included in the anode of the secondary battery, the charge capacity and the lifespan characteristic of the battery, and compatibility with the existing anode materials, may be improved.

Although some embodiments have been disclosed herein, it should be understood by those skilled in the art that these embodiments are provided by way of illustration only, and that various modifications, changes, and alterations can be made without departing from the spirit and scope of the invention. Therefore, it should be understood that the foregoing embodiments are provided for illustrative purposes only and are not to be construed in any way as limiting the present invention.

1. A carbon-silicon composite in which silicon (Si)-block copolymer core-shell particles are embedded in a carbonaceous substance,
wherein a cross sectional image of the carbon-silicon composite is taken by scanning electron microscope (SEM), and the image is divided into nine equal parts with a three-by-three matrix,
0≦|Xₙ−Y|≦0.5Y is satisfied,
wherein Xₙ (n is an integer of 1 to 9) denotes a ratio (%) of an area occupied by nano silicon (Si) fine particles to an area of the composite in each of the nine equal parts, and Y denotes an average value of a ratio (%) of the area occupied by the nano silicon (Si) fine particles to the area of the composite in whole parts.

2. The carbon-silicon composite of claim 1, wherein a difference between any two values of Xₙ (n is an integer of 1 to 9) is 0.5Y or less.

3. The carbon-silicon composite of claim 1, wherein
$$0 \leq \frac{\begin{matrix}{\sum }_{n = 1}^{6} \vert {X}_{n + 3} - {X}_{n} \vert + \\ {\sum }_{n = 1}^{3} ( \vert {X}_{3 n} - {X}_{3 n - 1} \vert + \vert {X}_{3 n - 1} - {X}_{3 n - 2} \vert )\end{matrix}}{12} \leq 0.3 Y$$
is satisfied.

4. The carbon-silicon composite of claim 1, wherein in the silicon (Si)-block copolymer core-shell particles, silicon (Si) core; and a block copolymer shell form a spherical micelle structure on the basis of the silicon (Si) core, the block copolymer shell including blocks having a high affinity with silicon and blocks having a low affinity with silicon.

5. The carbon-silicon composite of claim 4, wherein the block having a high affinity with silicon (Si) is poly acrylic acid, poly acrylate, poly methyl methacrylic acid, poly methyl methacrylate, poly acryamide, carboxymethyl cellulose, poly vinyl acetate, or polymaleic acid.

6. The carbon-silicon composite of claim 4, wherein the block having a low affinity with silicon (Si) is poly styrene, poly acrylonitrile, poly phenol, poly ethylene glycol, poly lauryl methacrylate, or poly vinyl difluoride.

7. The carbon-silicon composite of claim 4, wherein when 90% cumulative mass-particle size distribution diameter is D90, and 50% cumulative mass-particle size distribution diameter is D50 in a particle distribution in a slurry solution of the silicon (Si)-block copolymer core-shell particle, 1≦D90/D50≦1.4 is satisfied.

8. The carbon-silicon composite of claim 4, wherein when 50% cumulative mass-particle size distribution diameter is D50 in a particle distribution in a slurry solution of the silicon (Si)-block copolymer core-shell particle, 2 nm<D50<120 nm is satisfied.

9. The carbon-silicon composite of claim 1, wherein a mass ratio of silicon to carbon is 0.5:99.5 to 30:70.

10. The carbon-silicon composite of claim 1, wherein the carbonaceous substance is an amorphous carbon, and is at least one selected from soft carbons and hard carbons.

11. The carbon-silicon composite of claim 1, wherein a carbonization yield of the carbon-silicon composite is 5% to 30%.

12. The carbon-silicon composite of claim 1, wherein a carbonization yield of the carbonaceous substance is 40% to 80%.

13. An anode active material for a secondary battery comprising:
a core layer consisting of the carbon-silicon composite of claim 1; and
a shell layer homogeneously coated on a surface of the core layer and including a conductive material and a carbon material for fixing the conductive material.

14. The anode active material for a secondary battery of claim 13, wherein the core layer has a content of 60 wt % to 99 wt % with regard to the anode active material.

15. The anode active material for a secondary battery of claim 13, wherein the conductive material in the shell layer includes at least one selected from the group consisting of carbon black, acetylene black, Ketjen black, furnace black, carbon fiber, fullerene, copper, nickel, aluminum, silver, cobalt oxide, titanium oxide, polyphenylene derivative, polythiophene, polyacene, polyacetylene, polypyrrole, polyaniline and a combination thereof.

16. The anode active material for a secondary battery of claim 13, wherein the conductive material in the shell layer has a content of 1 wt % to 40 wt % with regard to the anode active material.
